(19) United States
(12) Patent Application Publication
(10) Pub. No.: US 2014/0229299 A1
(43) Pub. Date: Aug. 14, 2014

(54) SYSTEMS FOR DISTRIBUTING CONTENT FROM AFFILIATED ENTITY RANKINGS

(71) Applicants: Adam J. Spanky Compain, San Francisco, CA (US); Kenneth Fineo, Charlottesville, VA (US)

(72) Inventors: Adam J. Spanky Compain, San Francisco, CA (US); Kenneth Fineo, Charlottesville, VA (US)

(21) Appl. No.: 13/765,197

(22) Filed: Feb. 12, 2013

(51) Int. Cl. G06Q 30/02

(52) U.S. Cl. CPC G06Q 30/0277
USPC 705/14.73

(57) ABSTRACT

Systems, methods, and computer-readable storage media that may be used to provide content based on third-party ratings are provided. One method includes receiving data identifying a plurality of affiliated entities that a content provider wishes to promote within published content. The method further includes receiving rating data from one or more third party entities. The rating data relates to one or more of the plurality of affiliated entities. The method further includes selecting two or more affiliated entities from among the plurality of affiliated entities for inclusion within a published content item based on the ranking data from the one or more third party entities. The method further includes generating the published content item including content relating to the two or more selected affiliated entities.

### BACKGROUND

Online content publication systems allow content publishers to publish content that promotes the content publisher and/or products/services that the content publisher sells. For example, manufacturers may publish content that promotes the manufacturers' products or brand to consumers. Retailers may publish content that promotes the retailers' stores and/or products that the retailers sell. However, online content publication systems do not provide a mechanism for entities such as manufacturers to promote affiliated entities (e.g., retailers that sell the manufacturers' products) in published content.

### SUMMARY

One implementation of the disclosure relates to a method that includes receiving, at a computerized content publication system from a content provider, data identifying a plurality of affiliated entities that the content provider wishes to promote within published content. The method further includes receiving, at the content publication system from one or more computerized systems of one or more third party entities, rating data from the one or more third party entities. Each of the one or more third party entities is an entity other than the content provider and the plurality of affiliated entities. The rating data relates to one or more of the plurality of affiliated entities. The method further includes selecting, at the content publication system, two or more affiliated entities from among the plurality of affiliated entities for inclusion within a published content item based on the ranking data from the one or more third party entities. The method further includes generating, at the content publication system, the published content item including content relating to the two or more selected affiliated entities. The method further includes transmitting data representing the published content item to one or more computerized user devices. The data is configured to cause the one or more user devices to display the published content item within an interface of the one or more user devices.

Another implementation of the disclosure relates to a system including at least one computing device operably coupled to at least one memory and configured to receive, from a content provider, data identifying a plurality of affiliated entities that the content provider wishes to promote within published content. The computing device is further configured to receive rating data from one or more third party entities. Each of the one or more third party entities is an entity other than the content provider and the plurality of affiliated entities. The rating data relates to one or more of the plurality of affiliated entities. The computing device is further configured to select two or more affiliated entities from among the plurality of affiliated entities for inclusion within a published content item based on the ranking data from the one or more third party entities. The computing device is further configured to generate the published content item including content relating to the two or more selected affiliated entities.

Another implementation of the disclosure relates to a computer-readable storage medium having instructions stored thereon that, when executed by a processor, cause the processor to perform operations including receiving, from a content provider, data identifying a plurality of affiliated entities that the content provider wishes to promote within published content. The operations further include receiving rating data from one or more third party entities. Each of the one or more third party entities is an entity other than the content provider and the plurality of affiliated entities. The rating data relates to one or more of the plurality of affiliated entities. The operations further include selecting two or more affiliated entities from among the plurality of affiliated entities for inclusion within a published content item based on the ranking data from the one or more third party entities. The operations further include generating the published content item including content relating to the two or more selected affiliated entities. The operations further include transmitting data representing the published content item to one or more computerized user devices. The data is configured to cause the one or more user devices to display the published content item within an interface of the one or more user devices.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1A is a diagram of a promotion chain illustrating promotion channels available to a manufacturer under a traditional content publication system according to an illustrative implementation.

FIG. 1B is a diagram of types of promotion that are and are not available to a retailer and manufacturer under a traditional content publication system according to an illustrative implementation.

FIG. 1C is a diagram of a promotion chain illustrating promotion channels available to a content publisher such as a manufacturer under the content publication system of the present disclosure according to an illustrative implementation.

FIG. 2 is a block diagram of a content publication system and associated environment according to an illustrative implementation.

FIG. 3 is a flow diagram of a process for generating content that promotes affiliated entities according to an illustrative implementation.

FIGS. 4 and 5 are display images of example content items that may be generated using the process of FIG. 3 according to illustrative implementations.

FIG. 6 is a block diagram of a computing device according to an illustrative implementation.

### DETAILED DESCRIPTION

Referring generally to the Figures, various illustrative systems and methods are provided that allows content providers to publish content promoting affiliated entities based on rankings or reviews provided by a third party. Content publication systems typically allow for the following types of content to be published within a basic manufacturer->retailer->consumer business model: (1) manufacturers can promote their products to consumers; (2) retailers can promote the products they sell to consumers; and (3) retailers can promote their stores to consumers. Such systems may not provide content publishers (e.g., manufacturers) with a way to promote entities with which they are affiliated (e.g., retailers that sell the manufacturers' products) to consumers.

A content publication system according to illustrative implementations of the present disclosure may allow a content provider to promote one or more affiliated entities using third party data such as ratings or rankings. For example, a beverage manufacturer may establish a content campaign in which the published content promotes bars and/or restaurants that serve beverages manufactured by the beverage manufacturer to consumers based on third party rankings such as those published by Zagat. The content provider may provide a list of affiliated entities to the content publication system, and the content publication system may use the third party data to determine one or more of the affiliated entities to be featured in the published content. In some implementations, the content publication system may include in the published content a predetermined number of affiliated entities having the highest rankings/scores under the third party data or all affiliated entities having a ranking/score above a particular level. The published content may include links to resources associated with each of the selected affiliated entities (e.g., a resource published by the affiliated entity and/or a third party resource such as a map identifying a location of the affiliated entity). In some implementations, the third party ranking may appear next to a link or other data relating to the selected affiliated entities. In some implementations, the content may be a special type of content triggered in response to particular predetermined trigger conditions, such as a superlative (e.g., “best”) and/or location (e.g., “best restaurants in Chicago”).

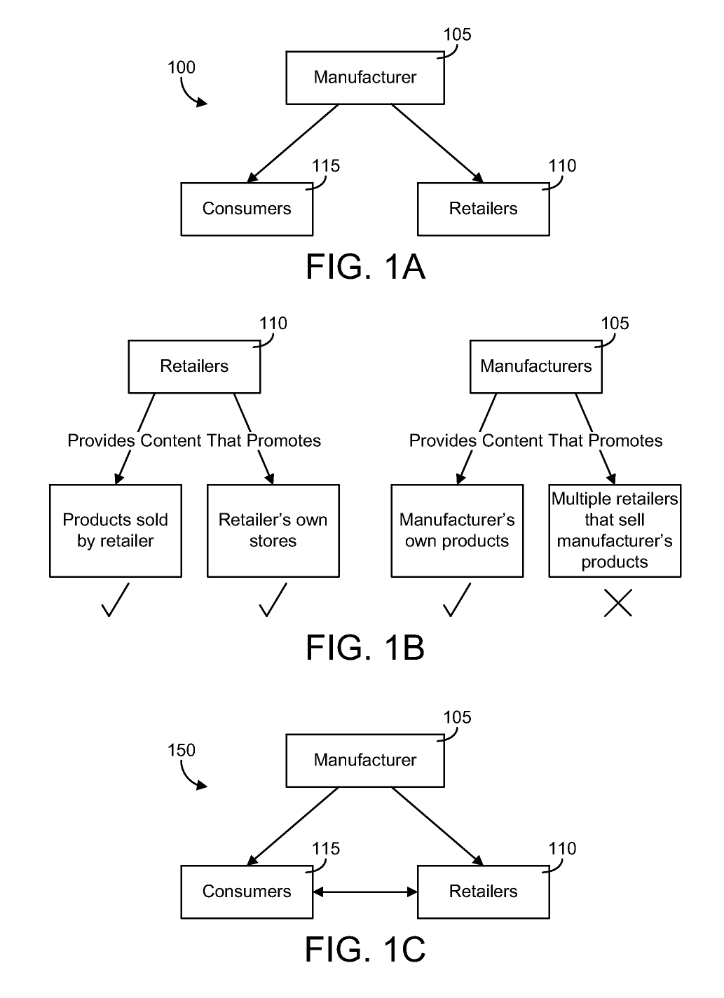

FIG. 1A shows a promotion chain 100 illustrating promotion channels available to a manufacturer 105 under a traditional content publication system according to an illustrative implementation. Traditional content publication systems allow manufacturer 105 to promote products to retailers 110 in an effort to encourage retailers 110 to sell the products (e.g., a “business-to-business,” or B2B, channel). Manufacturer 105 may also promote the products directly to consumers 115 in an effort to encourage consumers 115 to purchase the products (e.g., a “business-to-consumer,” or B2C, channel). Traditional content publication systems do not provide opportunities to publish content specifically designed for manufacturer 105 to promote retailers 110 that sell products manufactured by manufacturer 105 to consumers 115. This results in an “incomplete triangle” or missed opportunity to connect consumers 115 who may wish to purchase products made by manufacturer 105 with retailers 110 through which consumers 115 may purchase the products.

This limitation of traditional content publication systems is further illustrated with respect to FIG. 1B, which illustrates types of promotion that are and are not available to retailer 110 and manufacturer 105 using a traditional content publication system according to an illustrative implementation. Retailer 110 may publish content that promotes products sold by retailer 110 and content that promotes the stores, website, computing device application, etc. of retailer 110. Manufacturer 105 may publish content that promotes the products produced by manufacturer 105. Traditional content publication systems do not provide a mechanism for manufacturer 105 to publish content promoting multiple retailers 110 that sell the products produced by manufacturer 105 in an effort to connect those retailers 110 with consumers.

FIG. 1C illustrates another example promotion chain 150 that shows promotion channels available to a content publisher such as manufacturer 105 under a content publication system of the present disclosure according to an illustrative implementation. Promotion chain 150 provides the same channels linking manufacturer 105 with retailers 110 and manufacturer 105 with consumers 115 as in promotion chain 100. Content publication systems of the present disclosure also provide methods for manufacturer 105 to help achieve a link between retailers 110 that are affiliated with manufacturer 105 (e.g., sell products produced by manufacturer 105) and consumers 115 that may be interested in purchasing products made by manufacturer 105, completing the “incomplete triangle.” Connecting affiliated retailers 110 with consumers 115 may increase business opportunities (e.g., sales) for manufacturer 105. For example, a consumer 115 who may be interested in purchasing a product made by manufacturer 105 may be presented with a content item that identifies one or more retailers 110 that are near a current location of the consumer 115 and sell the product. This may provide an opportunity for the consumer 115 to immediately purchase the product at one of the identified retailers 110 and may increase the likelihood that the consumer 115 will move ahead with the purchase rather than changing his or her mind. Additionally, the content publication system may provide manufacturer 105 with a way to promote those retailers 110 who are most valuable to manufacturer 105 (e.g., sell a large amount of products made by manufacturer 105, promote products made by manufacturer 105 in content they publish, etc.). The content publication system may also provide more useful results to users who are searching for particular types of information, such as location-based information.

While FIGS. 1A through 1C and illustrative implementations discussed herein identify manufacturers of products as an example of content providers who may utilize the content publication system, the present disclosure is equally applicable to providers of services and/or other content providing entities having a relationship with one or more other entities that the content providing entities may wish to promote to customers.

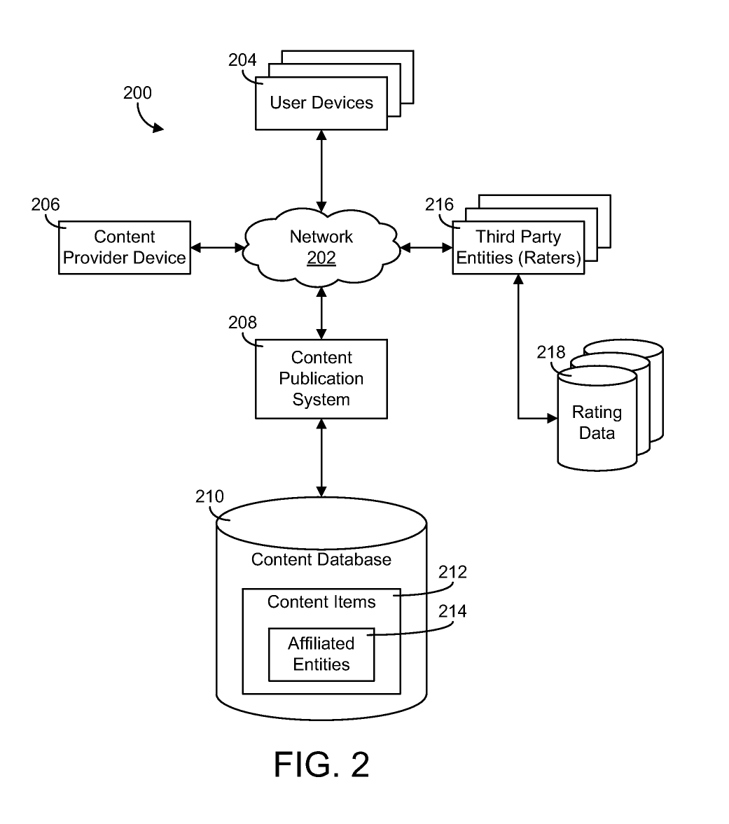

Referring now to FIG. 2, and in brief overview, a block diagram of a content publication system 208 and associated environment 200 is shown according to an illustrative implementation. One or more user devices 204 may be used by a user to perform various actions and/or access various types of content, some of which may be provided over a network 202 (e.g., the Internet, LAN, WAN, etc.). For example, user devices 204 may be used to access websites (e.g., using an internet browser), media files, and/or any other types of content. Content publication system 208 may be configured to select content for display to users within resources (e.g., webpages, applications, etc.) and to provide content from a content database 210 to user devices 204 over network 202 for display within the resources. The content from which content publication system 208 selects items may be provided by one or more content providers via network 202 using a content provider device 206.

In some implementations, bids for content to be selected by content publication system 208 may be provided to content publication system 208 from content publishers participating in an auction using devices, such as content provider device 206, configured to communicate with content publication system 208 through network 202. In such implementations, content publication system 208 may determine content to be published based at least in part on the bids.

Referring still to FIG. 2, and in greater detail, user devices 204 and/or content provider device 206 may be any type of computing device (e.g., having a processor and memory or other type of computer-readable medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 204 may be set-top boxes or other devices for use with a television set. In some implementations, content may be provided via a web-based application and/or an application resident on a user device 204. In some implementations, user devices 204 and/or content provider device 206 may be designed to use various types of software and/or operating systems. In various illustrative implementations, user devices 204 and/or content provider device 206 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 204 and/or content provider device 206 may be configured to receive data from various sources using a network 202. In some implementations, network 202 may comprise a computing network (e.g., LAN, WAN, Internet, etc.) to which user devices 204 and/or content provider device 206 may be connected via any type of network connection (e.g., wired, such as Ethernet, phone line, power line, etc., or wireless, such as WiFi, WiMAX, 3G, 4G, satellite, etc.). In some implementations, network 202 may include a media distribution network, such as cable (e.g., coaxial metal cable), satellite, fiber optic, etc., configured to distribute media programming and/or data content.

Some content that may be accessed via user devices 204 may include content that has been selected to appear in conjunction with certain resources through an auction or other content selection process. For example, a portion of a search result interface or another resource may be configured to display content that has been selected through the use of an auction. Content publication system 208 may be configured to receive bids from auction participants (e.g., content providers) and select content to be displayed in resources (e.g., on webpages) based on the bids. In some implementations, content may be ranked based on bids associated with the content. A search engine or other resource operator may receive revenue by auctioning a certain set of keywords to auction participants. Auction participants may place auction bids for the ability to include their content on the search result resource, whenever a user searches using a keyword in the set. For example, an online manufacturer of golf equipment may participate in an auction for the golf-related set of keywords. If a user searches for the term “golf,” and the manufacturer is determined to be the winner of the auction, content from the manufacturer may appear in the same resource as the search results. A provider of a website devoted to a particular topic may also receive revenue by auctioning off the ability to place content with his or her resource (e.g., embedded in a webpage, in a pop-up window, etc.). In some implementations, the provider of the website may be a different entity than the provider of content publication system 208. Similar to bidding on search results, an auction participant may place a bid in the auction using a set of keywords that corresponds to keywords found in the text of the resource. In some implementations, the auction bids may additionally or alternatively include criteria other than keywords, such as user interests, locations (e.g., geographic areas), semantic entities of resources (e.g., web pages), etc.

In some implementations, the content provider may create an account with content publication system 208. Associated with the account may be data relating to which content the content provider wishes to use, a daily budget to spend, topical categories of resources on which the content is to be placed (e.g., resources related to Sports>Golf, etc.), one or more bid amounts, and/or other data that may be used by content publication system 208 to select content to be displayed by user devices 204. When a user device 204 interacts with a resource that participates in the auction network, content publication system 208 may compare bids among auction participants to select content to be included in the resource. In some implementations, bids may be received from one or more content provider devices 206, and information relating to the bids, including the content associated with the bids, may be stored in content database 210 (e.g., in a content items portion 212). Content provider device 206 may be similar devices and/or have similar characteristics and features as described with respect to user devices 204.

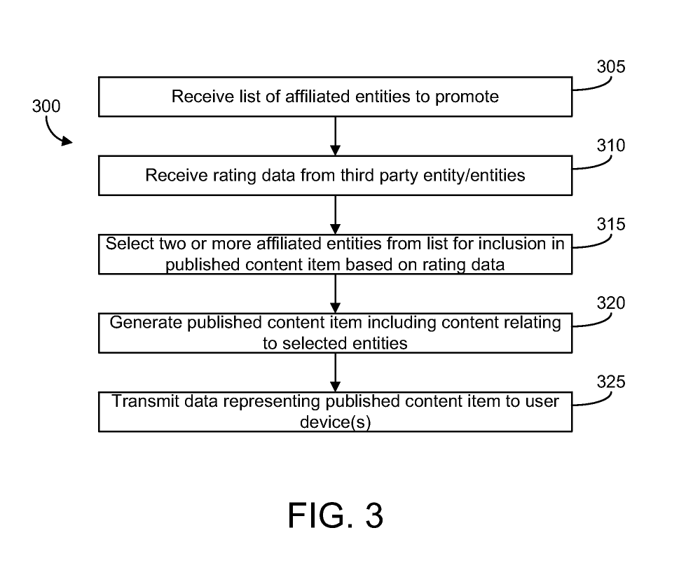

Content publication system 208 is configured to allow a content provider to generate and submit content items for publication (e.g., as part of bids) that feature and/or promote one or more entities that are affiliated with the content provider. FIG. 3 illustrates a flow diagram of a process 300 for generating content that promotes affiliated entities according to an illustrative implementation. Referring to both FIGS. 2 and 3, content publication system 208 may receive a list of affiliated entities that the content provider wishes to promote from content provider device 206 via network 202 (305). In some implementations, the content provider may be a producer of products and/or services and the affiliated entities may be retailers or other entities that sell or otherwise feature the products/services of the manufacturer. In some implementations, the content provider may be an entity who is interested in promoting one or more other entities regardless of whether or not the content provider has a financial interest in the promoted entities. For example, a content provider may provide a list of philanthropic organizations whose causes the content provider wishes to support. The use of the term “affiliated entities” herein is not intended to imply that the content provider must have a formal relationship or legal relationship with the affiliated entities, rather only that the content provider wishes to promote the affiliated entities through published content.

The list of affiliated entities may be provided to content publication system 208 in conjunction with or separate from content that the content provider wishes to be published. In some implementations, the list of affiliated entities may be included as part of a bid for content to be published submitted by the content provider (e.g., submitted along with the actual content item or creative). In some implementations, the list of affiliated entities may be provided separate from one particular content item for the purpose of being applied to a group of content items, such as a content campaign relating to a particular product or service. For example, a beverage manufacturer may create a content campaign featuring several types of beverages made by the manufacturer, and the beverage manufacturer may provide a list of restaurants that serve the manufacturer's beverages to be applied to part or all of the content submissions or bids submitted as part of the campaign. The list of affiliated entities may be stored in an affiliated entities portion 214 of content database 210 for retrieval by content publication system 208 when generating content to be published.

In some implementations, content providers may be free to determine what affiliated entities and/or how many entities to include within the list. For example, a content provider may determine that an entity may be included within the list if the entity sells a certain amount of the content provider's products or services, if the entity features the content provider or its products/services prominently in its marketing materials, or for any other reason. For example, a producer of beverages may include restaurants or other establishments where a specified percentage of beverages served are made by the beverage producer, a golf equipment manufacturer may include golf courses that sell more of the manufacturer's clubs in their pro shops than other brands, a shampoo manufacturer may include salons that use its shampoo, etc. In some implementations, a submitted list may be partitioned into different geographic locations. For example, a list submitted by a golf club manufacturer may include separate lists of affiliated courses in each of the New York, Chicago, San Diego, and Dallas areas. In some implementations, content publication system 208 may require that the submitted list include a minimum number of affiliated entities per geographic location (e.g., more than 3, more than 5, more than 10, etc.) to prevent brands from biasing the list.

Content publication system 208 may also receive rating data from one or more third party entities (rating parties) (310). Content publication system 208 may receive the rating data by communicating with third party entity systems 216 having rating data stored in one or more rating databases 218. The third party rating entities may include any entity that rates, ranks, or otherwise substantively reviews other entities. In some implementations, the third party rating entities may be organizations that create ratings or rankings internally (e.g., Zagat) and/or organizations that compile rankings based on submitted user reviews (e.g., Yelp). In some implementations, content publication system 208 may only retrieve rating data from third party entities that utilize quantitative ratings and/or rankings so that content publication system 208 can organize and rank entities from the list of affiliated entities based on the rating (e.g., numerical rating). In some implementations, content publication system 208 may utilize rating data from third party entities that include only qualitative ratings. In some implementations, content publication system 208 may retrieve rating data and store the rating data in content database 210. For example, content publication system 208 may obtain rating data periodically, according to a schedule, etc., store the data in database 210, and use the stored data to prepare content items to be published. In some implementations, content publication system 208 may retrieve rating data in real-time or near real-time while preparing content items for publication to ensure that the ratings are as current as possible.

In some implementations, content publication system 208 may be configured to utilize the same third party rating source or sources to prepare every published content item for a particular category (e.g., restaurants, entertainment venues, etc.). For example, any content item relating to restaurants may be generated using the same one or more third party ratings. This may help provide the user with a consistent experience. In some implementations, the content provider may be allowed to select which third party ratings the content provider wishes to be used in generating content items for the content provider (e.g., from among a list of available third party ratings).

Content publication system 208 may select two or more affiliated entities from the list for inclusion in the published content item based on the rating data (315). In some implementations, content publication system 208 may select a predetermined number of affiliated entities from the list having the highest rating under the rating data. For example, content publication system 208 may select the top three affiliated entities from the list for a particular content item being published. In some implementations, content publication system 208 may select some or all of the entities having a rating above a certain threshold rating. For example, content publication system 208 may select some or all of the listed entities having a rating higher than 75 on a scale of 0 to 100, or a rating of “B” or above on a F to A grading scale. In some implementations, a combination of selection methods may be used. For example, the top three listed entities by rating may be selected for inclusion in the published content item, but only if they all exceed a threshold rating level. Various other selection criteria may be used based on the rating data according to other illustrative implementations. In some implementations, the rating data may be the sole criterion for which affiliated entities are selected for inclusion in the published content item.

In some implementations, selection of the affiliated entities to be included in the published content item may occur dynamically, or after the content item has been selected for publication (e.g., as part of a bidding process). For example, the list of affiliated entities and the content item may be associated with a bid submitted to content publication system 208. The bid may be associated with one or more triggering keywords or phrases. When the triggering keywords or phrases are detected in input associated with user activity on a user device 204, content publication system 208 may select a content item to be published to the user on user device 204, for example, based on a comparison of the bid with other bids submitted for the same or similar triggering keywords and/or phrases. After the bid is chosen as a winning bid, content publication system 208 may compare the list of affiliated entities with the rating data and select the affiliated entities from the list that will be included in the published content item. Dynamically selecting the affiliated entities from the list (e.g., instead of selecting the entities when the list is submitted) may help ensure that the ratings used to determine which entities are selected from the list are current at the time of publication of the content item.

In some implementations, selection of the affiliated entities may be performed in part based on a geographic location (e.g., identified within the input relating to the user activity). For example, a bid may include a bid to display a content item in response to a triggering phrase “best cocktail in (location),” where (location) includes one of six locations, such as New York, Chicago, Los Angeles, San Francisco, Houston, and Tampa Bay. The list of affiliated entities may include six groups of affiliated entities, each of which is connected to one of the locations. If an input phrase of “best cocktail in Houston” results in the bid being selected, content publication system 208 may be configured to select affiliated entities for inclusion from among the group of affiliated entities associated with the Houston location.

In some implementations, published content items that promote affiliated entities as described herein may be triggered for selection only upon detection of input relating to the user that satisfies one or more triggering characteristics. For example, affiliate-promoting content items may be selected when the detected input includes one or more of a superlative (e.g., “best” or “greatest”), a location indicator (e.g., “in” or “near”), and/or a market or geographic location (e.g., “Chicago” or “nyc”). Any type of triggering phrase or condition could be utilized to trigger selection of an affiliate-promoting bid according to various illustrative implementations.

In some implementations, entities may be selected from the list based on a combination of rating data from different sources. For example, if rating data from multiple different sources relates to the same category (e.g., restaurants), the entities in that category may be ranked and selected for inclusion based on a combination of the rating data sources. In some implementations, if the rating data sources utilize different numerical or quantitative scales for ratings, the scales may be normalized to one another to allow combination of the ratings for the purposes of comparing the entities on the list.

In some implementations, the entities may be selected based in part on input relating to the user. For example, if the input indicates that the user is interested in a particular characteristic, content publication system 208 may select entities based in part on that characteristic. In one example, an input phrase in a search engine may be “best cheap golf courses near Chicago,” and content publication system 208 may select golf courses from a list of affiliated golf courses that have green fees under a particular price or within a particular price category. In various implementations, the characteristic data for the affiliated entities may be provided by the content provider as part of the list, collected by content publication system 208 based on the name and/or other data provided by the content provider, included within the data provided by the third party rating entities, etc.

Once the affiliated entities have been selected, content publication system 208 may generate the published content item including content relating to the selected affiliated entities (320). The published content item may include a portion that relates to the content provider, such as a portion featuring the content provider's products/services/brands/etc. In some implementations, the published content item may include a link to a resource associated with the content provider (e.g., a website of the content provider, a social media profile associated with the content provider, location-based (e.g., mapping) service data relating to the content provider, etc.). Content publication system 208 may transmit data representing the published content item to one or more user devices (325). The data representing the published content item may cause the one or more user devices to display the published content item within an interface of the user devices.

One or more data items may be provided in the published content relating to each of the selected affiliated entities. In some implementations, the data items may include the rating data associated with the selected entity and/or a textual narrative from the third party rating entity relating to the selected entity. In some implementations, the data items may include a link associated with the selected entity, such as a link to a website of the selected entity, social media interface relating to the entity, location-based (e.g., mapping) service identifying a location of the entity, reservation service providing the user with the ability to make a reservation with the selected entity, etc. In some implementations, the published content item may include a link that allows a user to see an expanded list of affiliated entities (e.g., up to or including all of the entities on the list), such as within a mapping interface. In some implementations (e.g., when the content provider is paying for each user click-through), clicks on any of the links in the published content item, including those related to the affiliated entities, may be paid for by the content provider.

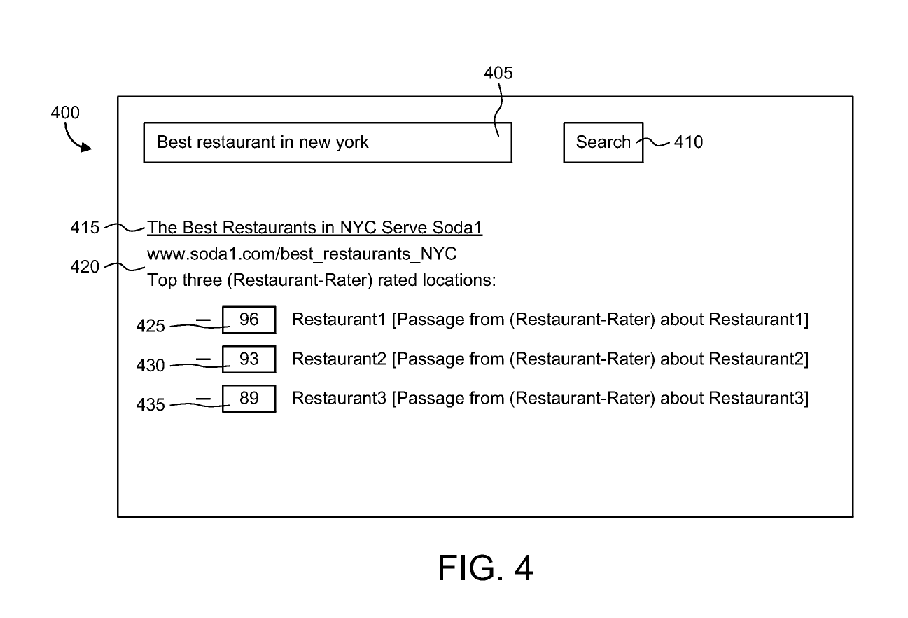

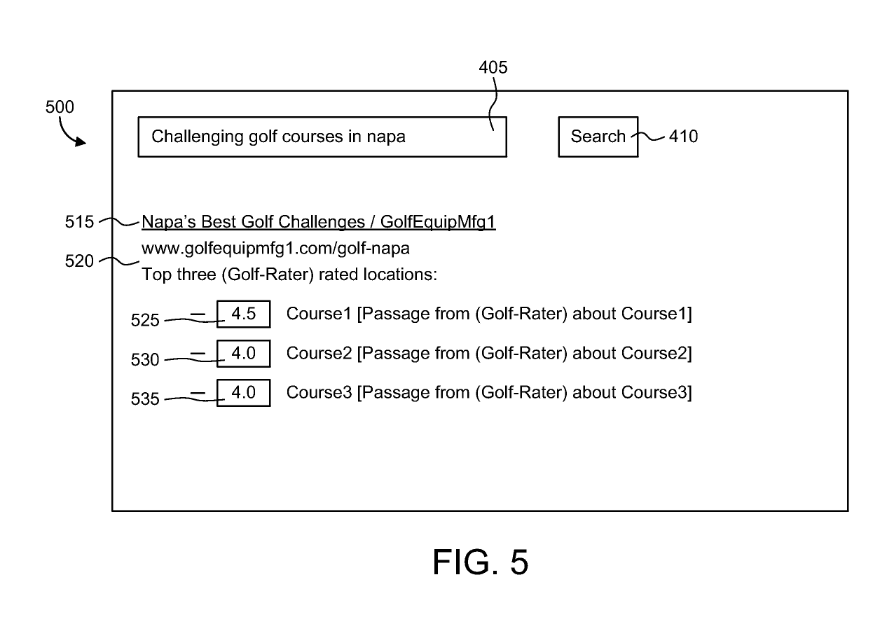

FIGS. 4 and 5 show display images 400 and 500, respectively, of example content items that may be generated using the process of FIG. 3 according to illustrative implementations. Referring first to FIG. 4, a display image 400 is shown that includes a published content item resulting from a bid by a content provider “Soda1.” In the illustrated example implementation, display image 400 is part of a search engine interface. The content item may be generated in response to a user entering the phrase “Best restaurant in New York” in search field 405 and selecting search button 410. Content publication system 208 may process the input string and determine that the submission of Soda1 is a winning submission (e.g., based on an auction process). Content publication system 208 may then obtain/retrieve rating data from a third party restaurant rating entity called “Restaurant-Rater” and use the rating data to select the top three affiliated restaurants from among a list of affiliated restaurants provided by Soda1 based on the rating data. The affiliated restaurants may be included in the list, for example, on the basis that they sell only Soda1 brand soft drinks in their restaurants. Content publication system 208 may generate the published content item using the selected affiliated restaurants.

The generated content item to be published may be provided within a results interface (e.g., in a particular content item area, such as at the top of the results interface). The published content item includes a content provider portion 415 relating to the content provider Soda1. In the illustrated implementation, content provider portion 415 includes a link that leads a user to a Soda1 website upon selection. The published content item also includes an affiliated entity portion 420 that provides information relating to the selected affiliated entities. In the illustrated implementation, affiliated entity portion 420 includes first affiliated entity information 425 including information relating to a top-rated (under the Restaurant-Rater ratings) affiliated entity Restaurant1, second affiliated entity information 430 relating to a second-rated affiliated entity Restaurant2, and third affiliated entity information 435 relating to a third-rated affiliated entity Restaurant3. Each of affiliated entity information 425, 430, and 435 may include rating information (e.g., a rating, ranking, score, etc., such as a quantitative and/or numerical rating), review text (e.g., a passage from the third party rating entity regarding the affiliated entity), or other types of information. In some implementations, content publication system 208 may allow the user and/or content provider to customize the amount/type of information shown in the published content item (e.g., more or less of the textual summary from the third party rating entity). In various embodiments, selecting a selectable item such as a link associated with affiliated entity information 425, 430, and 435 may lead the user to a website or other resource associated with the restaurant, a mapping interface or other location-based service used to identify a location of the restaurant, a social media interface associated with the restaurant, a reservations system configured to make reservations with the restaurant, etc.

FIG. 5 includes a display image 500 showing a content item that may be displayed when the example phrase “Challenging golf courses in napa” is entered into search field 405. In the illustrated example implementation, a content item submitted by a golf equipment manufacturer GolfEquipMfg1 is selected by content publication system 208. A content provider portion 515 includes information and/or links relating to GolfEquipMfg1. Content publication system 208 utilizes ratings from a third party rating entity Golf-Rater to select the top three affiliated golf courses from a list of affiliated courses provided by GolfEquipMfg1. The affiliated golf courses may be included in the list, for example, on the basis that the pro shops of the golf courses sell a certain percentage or amount of GolfEquipMfg1 equipment or feature GolfEquipMfg1 in their promotional materials. Information relating to the top three affiliated courses may be provided in an affiliated entity portion 520 (see affiliated entity information 525, 530, and 535, respectively).

In some embodiments, content publication system 208 may be configured to display information relating to the affiliated entities in an order according to the rating data (e.g., with the highest rating being displayed in the highest or most prominent position). In the illustrated example, Course2 and Course3 have the same rating under the Golf-Rater ratings. In some embodiments, content publication system 208 may be configured to position entities having the same rating according to a ranking provided within the list provided by the content provider. In some embodiments, content publication system 208 may be configured to order the information relating to the affiliated entities in whole or in part based on other factors, such as distance away from a current location of the user, characteristics/preferences of the user, etc.

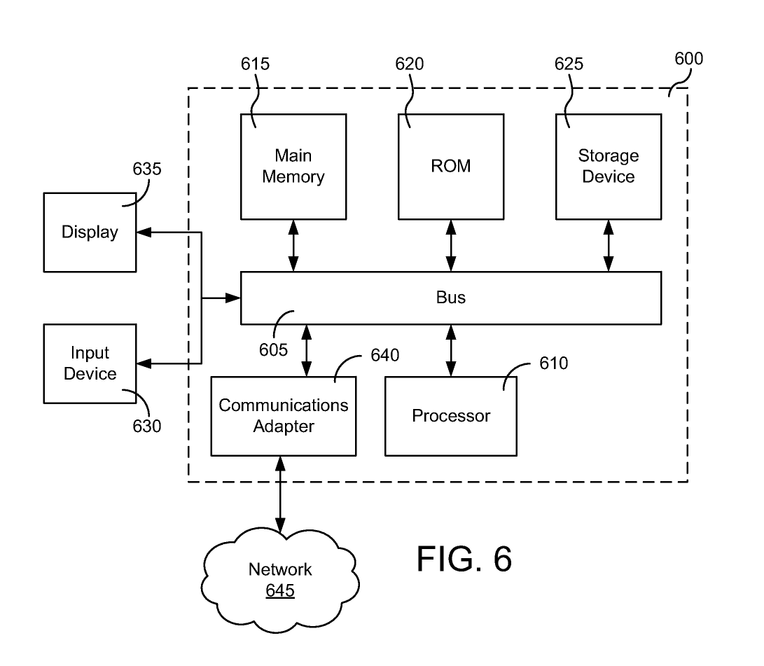

FIG. 6 illustrates a depiction of a computer system 600 that can be used, for example, to implement an illustrative user device 204, an illustrative content publication system 208, an illustrative content provider device 206, an illustrative third party entity system 216, and/or various other illustrative systems that may be used in the implementation of an environment in which online content may be provided as described in the present disclosure. The computing system 600 includes a bus 605 or other communication component for communicating information and a processor 610 coupled to the bus 605 for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information, and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

In some implementations, the computing system 600 may include a communications adapter 640, such as a networking adapter. Communications adapter 640 may be coupled to bus 605 and may be configured to enable communications with a computing or communications network 645 and/or other computing systems. In various illustrative implementations, any type of networking configuration may be achieved using communications adapter 640, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to implement illustrative implementations. Thus, implementations are not limited to any specific combination of hardware circuitry and software.

Although an example processing system has been described in FIG. 6, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a computerized content publication system from a content provider, data identifying a plurality of affiliated entities that the content provider wishes to promote within published content;
retrieving, at the content publication system from one or more computerized systems of one or more third party entities, rating data from the one or more third party entities, wherein each of the one or more third party entities is an entity other than the content provider and the plurality of affiliated entities, and wherein the rating data relates to one or more of the plurality of affiliated entities;
selecting, at the content publication system, two or more affiliated entities from among the plurality of affiliated entities for inclusion within a published content item based on the ranking data from the one or more third party entities;
generating, at the content publication system, the published content item including content relating to the two or more selected affiliated entities; and
transmitting data representing the published content item to one or more computerized user devices, wherein the data is configured to cause the one or more user devices to display the published content item within an interface of the one or more user devices.

2. The method of claim 1, wherein the content relating to the two or more selected affiliated entities included in the published content comprises rating data associated with the two or more selected affiliated entities.

3. The method of claim 1, wherein selecting two or more affiliated entities comprises selecting a predetermined number of affiliated entities having highest ratings under the rating data.

4. The method of claim 1, wherein selecting two or more affiliated entities comprises selecting affiliated entities having ratings that are above a predetermined rating threshold.

5. The method of claim 1, wherein the content relating to the two or more selected affiliated entities comprises one or more links to one or more resources associated with the two or more selected affiliated entities.

6. The method of claim 1, further comprising:
receiving input relating to a user;
determining whether the input includes one or more trigger characteristics; and
selecting the two or more affiliated entities and generating the published content item based on the input when the input includes one or more trigger characteristics.

7. The method of claim 1, further comprising receiving input relating to a user, wherein selecting two or more affiliated entities from among the plurality of affiliated entities comprises selecting the two or more affiliated entities based in part on the input relating to the user.

8. The method of claim 7, wherein the input relating to the user comprises a search query, and wherein the two or more affiliated entities are selected based in part on the search query.

9. A system comprising:
at least one computing device operably coupled to at least one memory and configured to:
receive, from a content provider, data identifying a plurality of affiliated entities that the content provider wishes to promote within published content;
receive rating data from one or more third party entities, wherein each of the one or more third party entities is an entity other than the content provider and the plurality of affiliated entities, and wherein the rating data relates to one or more of the plurality of affiliated entities;
select two or more affiliated entities from among the plurality of affiliated entities for inclusion within a published content item based on the ranking data from the one or more third party entities; and
generate the published content item including content relating to the two or more selected affiliated entities.

10. The system of claim 9, wherein the content relating to the two or more selected affiliated entities included in the published content comprises rating data associated with the two or more selected affiliated entities.

11. The system of claim 9, wherein the at least one computing device is configured to select a predetermined number of affiliated entities having highest ratings under the rating data.

12. The system of claim 9, wherein the at least one computing device is configured to select affiliated entities having ratings that are above a predetermined rating threshold.

13. The system of claim 9, wherein the content relating to the two or more selected affiliated entities comprises one or more links to one or more resources associated with the two or more selected affiliated entities.

14. The system of claim 1, wherein the at least one computing device is configured to:
receive input relating to a user;
determine whether the input includes one or more trigger characteristics; and
select the two or more affiliated entities and generating the published content item based on the input when the input includes one or more trigger characteristics.

15. A computer-readable storage medium having instructions stored thereon that, when executed by a processor, cause the processor to perform operations comprising:
receiving, from a content provider, data identifying a plurality of affiliated entities that the content provider wishes to promote within published content;
receiving rating data from one or more third party entities, wherein each of the one or more third party entities is an entity other than the content provider and the plurality of affiliated entities, and wherein the rating data relates to one or more of the plurality of affiliated entities;
selecting two or more affiliated entities from among the plurality of affiliated entities for inclusion within a published content item based on the ranking data from the one or more third party entities;
generating the published content item including content relating to the two or more selected affiliated entities; and
transmitting data representing the published content item to one or more user devices, wherein the data is configured to cause the one or more user devices to display the published content item within an interface of the one or more user devices.

16. The computer-readable storage medium of claim 15, wherein the content relating to the two or more selected affiliated entities included in the published content comprises rating data associated with the two or more selected affiliated entities.

17. The computer-readable storage medium of claim 15, wherein selecting two or more affiliated entities comprises selecting a predetermined number of affiliated entities having highest ratings under the rating data.

18. The computer-readable storage medium of claim 15, wherein selecting two or more affiliated entities comprises selecting affiliated entities having ratings that are above a predetermined rating threshold.

19. The computer-readable storage medium of claim 15, wherein the content relating to the two or more selected affiliated entities comprises one or more links to one or more resources associated with the two or more selected affiliated entities.

20. The computer-readable storage medium of claim 15, wherein the operations further comprise:
receiving input relating to a user;
determining whether the input includes one or more trigger characteristics; and
selecting the two or more affiliated entities and generating the published content item based on the input when the input includes one or more trigger characteristics.
